(19) United States
(12) Patent Application Publication
(10) Pub. No.: US 2015/0296471 A1
(43) Pub. Date: Oct. 15, 2015

(54) METHOD FOR PRESERVIING ACTIVE STATE OF IDLE MODE SIGNALING REDUCTION (ISR) FUNCTION

(71) Applicant: Samsung Electronics Co., Ltd., Gyeonggi-do (KR)

(72) Inventors: Anand Basavaraj BIRADAR, Bangalore (IN); Bharat Vinayak BHAT, Bangalore (IN)

(73) Assignee: Samsung Electronics Co., Ltd.

(21) Appl. No.: 14/686,412

(22) Filed: Apr. 14, 2015

(30) Foreign Application Priority Data
Apr. 14, 2014 (IN) 1944/CHE/2014

(51) Int. Cl. H04W 60/04; H04W 88/06; H04W 48/18

(52) U.S. Cl. CPC H04W 60/04; H04W 48/18; H04W 88/06

(57) ABSTRACT

An apparatus and method of a User Equipment (UE) for preserving an active state of an Idle Mode Signaling Reduction (ISR) function in a wireless communication network are provided. The method includes sending, by the UE, during an Inter-Radio Access technology (RAT)/System change, an area update request message to a node in the wireless communication network; receiving, by the UE, an area update accept message from the node; and setting, by the UE, a Temporary Identity Used in Next Update (TIN) parameter to a RAT-related Temporary Mobile Subscriber Identity (TMSI) to preserve the ISR function, in response to receiving the area update accept message, when a status of a periodic area update timer is deactivated.

### PRIORITY

This application claims priority under 35 U.S.C. §119(a) to Indian Provisional Patent Application Serial No. 1944/CHE/2014, which was filed in the Indian Property Office on Apr. 14, 2014, and to Indian Complete Patent Application Serial No. 1944/CHE/2014, which was filed in the Indian Property Office on Oct. 31, 2014, the entire disclosure of each of which is incorporated herein by reference.

### BACKGROUND

1. Field of the Disclosure

The embodiments disclosed herein relate generally to an Idle Mode Signaling Reduction (ISR) function in a wireless communication network, and more particularly, to preserving an active state of the ISR function in the wireless communication network.

2. Description of the Related Art

In wireless communication systems, an ISR function reduces mobile signaling between a User Equipment (UE) in an idle mode and a network. Specifically, the ISR function allows the UE to remain simultaneously registered in a Universal Terrestrial Radio Access Network (UTRAN) Routing Area (RA) and an Evolved Universal Terrestrial Radio Access Network (E-UTRAN) Tracking Area (TA) list. Therefore, the UE may make cell reselections between E-UTRAN and UTRAN, without having to send a Tracking Area Update (TAU) request or Routing Area Update (RAU) request. Basically, the UE may perform cell reselection, without sending the RAU request or the TAU request, as long as the UE remains within the registered RA and TA list. Consequently, by reducing the mobile signaling, the ISR function increases battery life of the UE.

FIG. 1A illustrates a conventional Inter-Radio Access technology (RAT)/System change from an E-UTRAN to a UTRAN/Global System for Mobile communication (GSM) Enhanced Data rates for GSM Evolution (EDGE) Radio Access Network (GERAN).

Referring to FIG. 1A, in step 101a, the UE 102 initiates a TAU procedure by sending a TAU request to a Mobility Management Entity (MME) 104. In step 102a, the MME 104 sends, to the UE 102, a TAU ACCEPT message indicating deactivation of a periodic area update timer T3412.

In response to the TAU ACCEPT message, the UE 102 deactivates T3412.

The UE 102 further sets a Temporary Identity used in Next update (TIN) to a Globally Unique Temporary Identifier (GUTI), upon successful attachment to an E-UTRAN, if the UE 102 transitions to connected mode.

Further, to initiate an Inter RAT/System change to the UTRAN/GERAN, in step 103a, the UE 102 sends a RAU request message to Serving GPRS Support Node (SGSN) 106.

The SGSN 106 retrieves context information of the UE 102 from the MME 104, and in step 104a, grants an ISR to the UE 102 in the RAU ACCEPT message.

The UE 102 may reset the TIN to a Packet Temporary Mobile Station Identity (P-TMSI), regardless of original value of the TIN, upon successful initial attachment to the GERAN/UTRAN.

If the UE 102 resets the TIN to PTMSI, the ISR is deactivated by the UE 102, though the network has activated the ISR.

As the ISR is deactivated, the UE 102 triggers the TAU during a next Inter RAT/System change from UTRAN/GERAN to E-UTRAN. As a result, the mobile signaling between the UE 102 and the network actually increases, even though the network has activated the ISR.

FIG. 1B illustrates a conventional Inter-RAT/System change from a UTRAN/GERAN to an E-UTRAN.

Referring to FIG. 1B, in step 101b, the UE 102 initiates the RAU procedure by sending the RAU request to the SGSN 106. In step 102b, the SGSN 106 sends, to the UE 102, the RAU ACCEPT message indicating deactivation of timer T3312.

In response to the RAU ACCEPT message, the UE 102 deactivates T3312 and sets the TIN to a P-TMSI, upon successful attachment to UTRAN/GERAN, if the UE 102 transitions to a connected mode.

To initiate the Inter RAT/System change to an E-UTRAN, in step 103b, the UE 102 sends a TAU request message to the MME 104.

The MME 104 retrieves context information of the UE 102 from the SGSN 106, and in step 104b, the MME 104 grants an ISR to the UE 102 in the TAU ACCEPT message.

The UE 102 may reset the TIN to a GUTI, regardless of original value of the TIN, upon a successful initial attachment to the E-UTRAN.

If the UE 102 resets the TIN to the GUTI, the ISR is deactivated by the UE 102 even though the network has activated the ISR. Further, as the ISR is deactivated, the UE 102 triggers the RAU during a next Inter RAT/System change from an E-UTRAN to a UTRAN/GERAN. Consequently, the mobile signaling between the UE 102 and the network again increases, even though the network has activated the ISR.

As described above, the current standard specification fails to specify setting of the TIN by the UE 102 when periodic update timers T3412 and T3312 are deactivated or not running during the Inter-RAT/System change from a UTRAN/GERAN to an E-UTRAN or from an E-UTRAN to a UTRAN/GERAN.

### SUMMARY

Accordingly, the present disclosure is made to address at least the problems and/or disadvantages described above and to provide at least the advantages described below.

An aspect of the present disclosure is to provide a system and method for preserving an active state of an ISR function in a wireless communication network.

Another aspect of the present disclosure is to provide a mechanism to set a TIN parameter to a RAT-related Temporary Mobile Subscriber Identity (TMSI) to preserve the ISR, in response to receiving a tracking area update accept message or a routing area update accept message.

Another aspect of the present disclosure is to provide a mechanism to set a TIN parameter to a RAT-related TMSI, when a GUTI is stored in the TIN parameter associated with a UE.

Another aspect of the present disclosure is to provide a mechanism to set a TIN parameter to a RAT-related TMSI, when a Packet domain-TMSI (P-TMSI) is stored in the TIN parameter associated with a UE.

In accordance with an aspect of the present disclosure, a method is provided for preserving an active state of an ISR function in a wireless communication network. The method includes sending, by the UE, during an Inter-RAT/System change, an area update request message to a node in the wireless communication network; receiving, by the UE, an area update accept message from the node; and setting, by the UE, a TIN parameter to a RAT-related TMSI to preserve the ISR function, in response to receiving the area update accept message, when a status of a periodic area update timer is deactivated.

In accordance with another aspect of the present disclosure, a UE is provided for preserving an active state of an ISR function in a wireless communication network. The UE includes a transceiver; and a controller configured to send, via the transceiver, during an Inter-RAT/System change, an area update request message to a node in the wireless communication network; receive, via the transceiver, an area update accept message from the network node; and set a TIN parameter to a RAT-related TMSI to preserve the ISR function, in response to receiving the area update accept message, when a status of a periodic area update timer is deactivated.

### BRIEF DESCRIPTION OF THE DRAWINGS

The above and other aspects, features, and advantages of certain embodiments of the present disclosure will be more apparent from the following detailed description taken in conjunction with the accompanying drawings, in which:

FIG. 1A illustrates a conventional Inter-RAT/System change from an E-UTRAN to a UTRAN/GERAN;

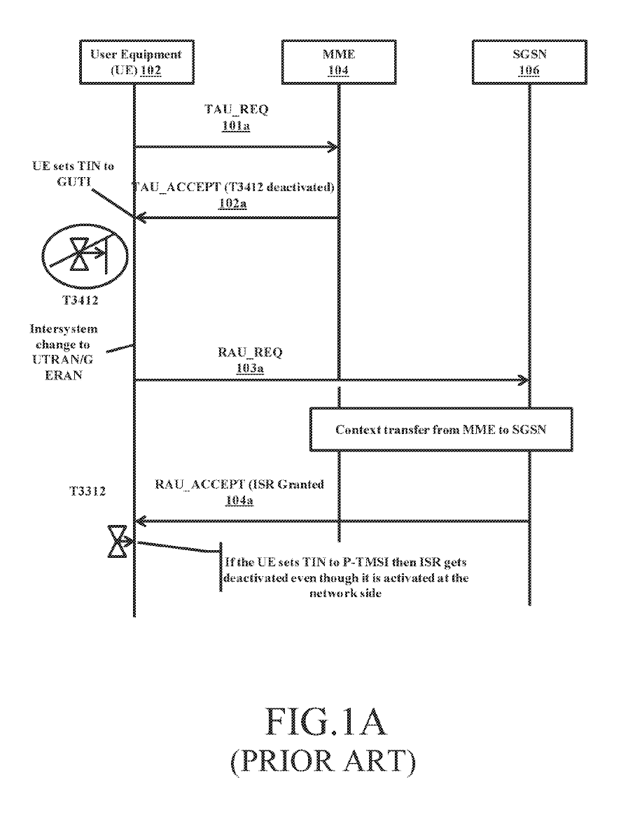

FIG. 1B illustrates a conventional Inter-RAT/System change from a UTRAN/GERAN to an E-UTRAN;

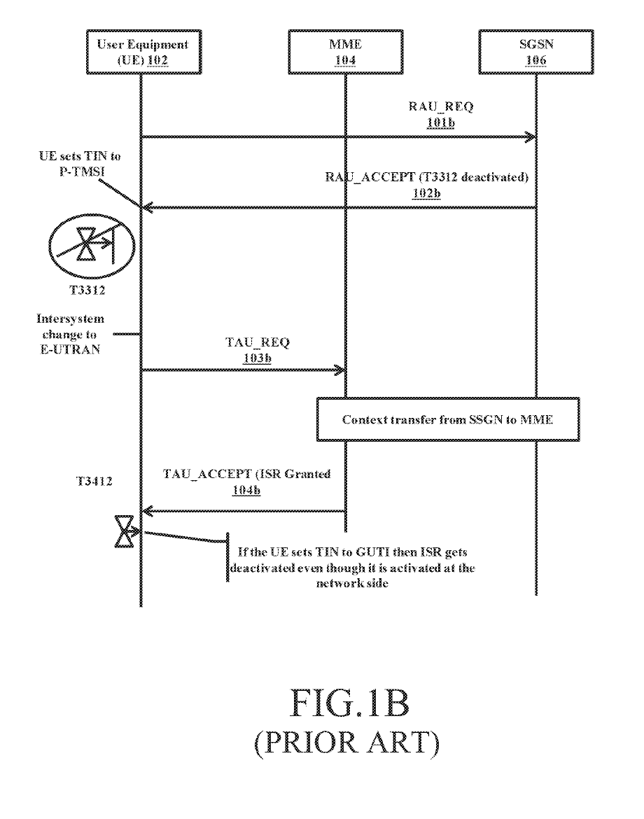

FIG. 2 illustrates a UE communicating with a first network entity and a second network entity during an Inter-RAT/System change, according to an embodiment of the present disclosure;

FIG. 3 is a flow chart illustrating a method for preserving an active state of an ISR function in a wireless communication network during an Inter-RAT/System change from an E-UTRAN to a UTRAN/GERAN, according to an embodiment of the present disclosure;

FIG. 4 is a flow chart illustrating a method for preserving an active state of an ISR function in a wireless communication network during an Inter-RAT/System change from a UTRAN/GERAN to an E-UTRAN, according to an embodiment of the present disclosure;

FIG. 5 is a flow chart illustrating a method for setting a TIN parameter in a UE during an Inter-RAT/System change from an E-UTRAN to a UTRAN/GERAN, according to an embodiment of the present disclosure;

FIG. 6 is a flow chart illustrating a method for setting a TIN parameter in a UE during an Inter-RAT/System change from a UTRAN/GERAN to an E-UTRAN, according to an embodiment of the present disclosure;

FIG. 7 is a sequence diagram illustrating a method for preserving an active state of an ISR function in a wireless communication network during an Inter-RAT/System change from an E-UTRAN to a UTRAN/GERAN, according to an embodiment of the present disclosure;

FIG. 8 is a sequence diagram illustrating a method for preserving an active state of an ISR function in a wireless communication network during an Inter-RAT/System change from a UTRAN/GERAN to an E-UTRAN, according to an embodiment of the present disclosure; and

FIG. 9 illustrates a computing environment for implementing a method for preserving an active state of ISR function in a wireless communication network, in accordance with an embodiment of the present disclosure.

### DETAILED DESCRIPTION OF EMBODIMENTS

The present disclosure and the various features and advantageous details thereof are described in detail below with reference to the non-limiting embodiments that are illustrated in the accompanying drawings. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments.

The term “or” as used herein, refers to a non-exclusive or, unless otherwise indicated.

Further, examples used herein are intended merely to facilitate an understanding of various ways in which the embodiments herein can be practiced and to further enable those skilled in the art to practice the embodiments herein. Accordingly, the examples should not be construed as limiting the scope of the embodiments herein.

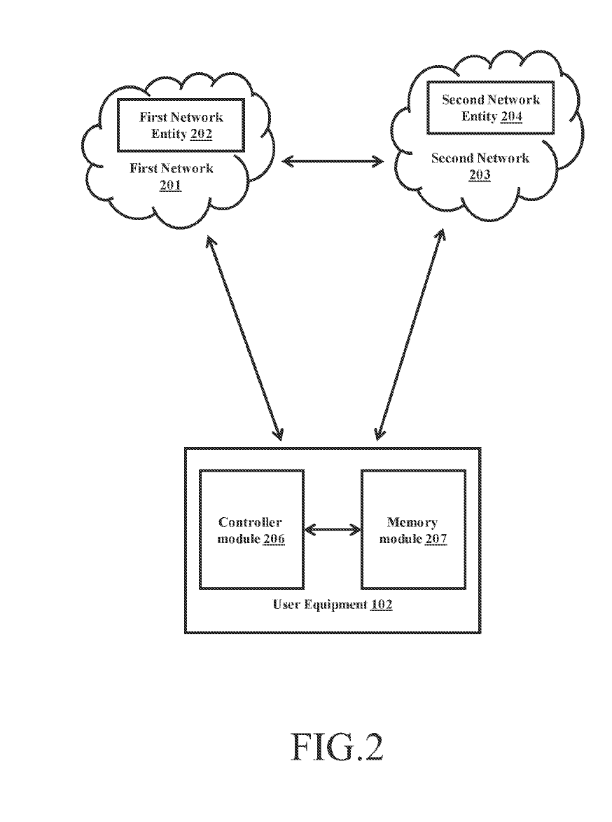

FIG. 2 illustrates a UE communicating with a first network entity and a second network entity during an Inter-RAT/System change, according to an embodiment of the present disclosure.

Referring to FIG. 2, the UE 102, which may also be referred to as a terminal, a mobile station, a subscriber unit, etc., communicates with a first network 201 and a second network 203. For example, the first network 201 and the second network 203 may be one of a Long Term Evolution (LTE) or Evolved Universal Terrestrial Radio Access Network (E-UTRAN), a 2^{nd} Generation (2G) network, or a 3^{rd} Generation (3G) network. The 2G and 3G networks may also be referred to as a UTRAN or GERAN.

The first network 201 is associated with a first network entity 202. The second network 203 is associated with a second network entity 204. For example, the first network entity 202 and the second network entity 204 may be an MME or an SGSN.

For example, the UE 102 may be a cellular phone, a Personal Digital Assistant (PDA), a wireless modem, a wireless communication device, a handheld device, a laptop computer, a cordless phone, a Wireless Local Loop (WLL) station, etc.

The UE 102 includes a controller module 206, e.g., a processor, and a memory module 207, e.g., a memory. In order to preserve the active state of the ISR function in the wireless communication network, the controller module 206 sends a tracking area update request message or a routing area update request message to at least one node in the wireless communication network. For example, the node in the wireless communication network may be an MME, an SGSN, or the like. The tracking area update request message or the routing area update request message is sent during an Inter-RAT/System change.

Further, the controller module 206 receives a tracking area update accept message or a routing area update accept message from at least one node. Further, the controller module 206 checks if a status of a periodic area update timer in the UE 102 is deactivated or not running in a previous RAT. When the status of the periodic area update timer is deactivated in the previous RAT, the controller module 206 sets a TIN parameter to a RAT-related TMSI to preserve the ISR. For example, for the status of the periodic area update timer, ‘deactivated’ can be referred to as ‘not running’ when the network deactivates the periodic area update timer.

When the status of the periodic area update timer is not running, the controller module 206 sets the TIN parameter to a RAT-related TMSI. As the ISR is preserved by the UE, unnecessary deactivation of the ISR is avoided, reducing the amount of mobile signaling.

Specifically, the TIN parameter is set to the RAT-related TMSI when a GUTI is stored in the TIN parameter associated with the UE 102.

Alternatively, the TIN parameter may be set to the RAT-related TMSI, when a P-TMSI is stored in the TIN parameter associated with the UE 102.

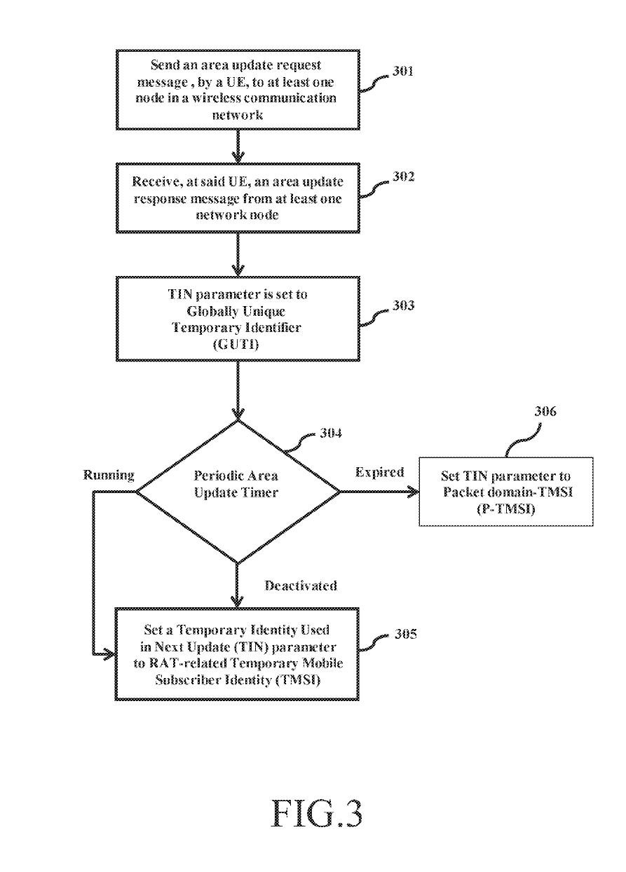

FIG. 3 is a flow chart illustrating a method for preserving an active state of an ISR function in a wireless communication network during an Inter-RAT/System change from an E-UTRAN to a UTRAN/GERAN, according to an embodiment of the present disclosure. Specifically, the method illustrated in FIG. 3 and other description described herein provide a basis for a control program, which can be implemented using a microcontroller, a microprocessor, or any computer readable storage medium.

Referring to FIG. 3, in step 301, the area update request message, e.g., an RAU request message, is sent by a UE, to a node, i.e., an SGSN, in the wireless communication network to initiate an RAU procedure. Herein, the SGSN may be referred to as a target SGSN, and an MME may be referred to as a source MME during an Inter-RAT/System change from an E-UTRAN to a UTRAN/GERAN.

After receiving the RAU request message, the target SGSN knows that the UE has arrived to the target side. The target SGSN then informs the source MME of the UE's arrival by sending a Forward Relocation Complete Notification (ISR Activated, Serving Gateway (GW) change) message. The target SGSN indicates to the source MME that the UE's context is maintained, when the Forward Relocation Complete Notification message indicates that the ISR is activated.

Further, the source MME acknowledges the Forward Relocation Complete Notification message, and the target SGSN activates the ISR in order to maintain the UE's context.

In step 302, the UE receives an area update accept message from the target SGSN. The area update accept message includes a RAU ACCEPT message, which indicates that the ISR is activated.

In step 303, the UE stores the TIN parameter as a GUTI.

In step 304, the UE checks a status of a periodic area update timer, T3412.

In step 305, the UE sets the TIN parameter to a RAT-related TMSI, when the status of T3412 is deactivated (or not running) or running. As described above, the setting of the TIN parameter to the RAT-related TMSI preserves deactivation of the ISR.

However, in step 306, the UE sets the TIN parameter to a P-TMSI, when the status of T3412 is expired.

The various steps illustrated in FIG. 3 may be performed in the order presented, in a different order, or simultaneously. Further, in some embodiments, some of the steps may be omitted, added, modified, skipped, and the like, without departing from the scope of the method.

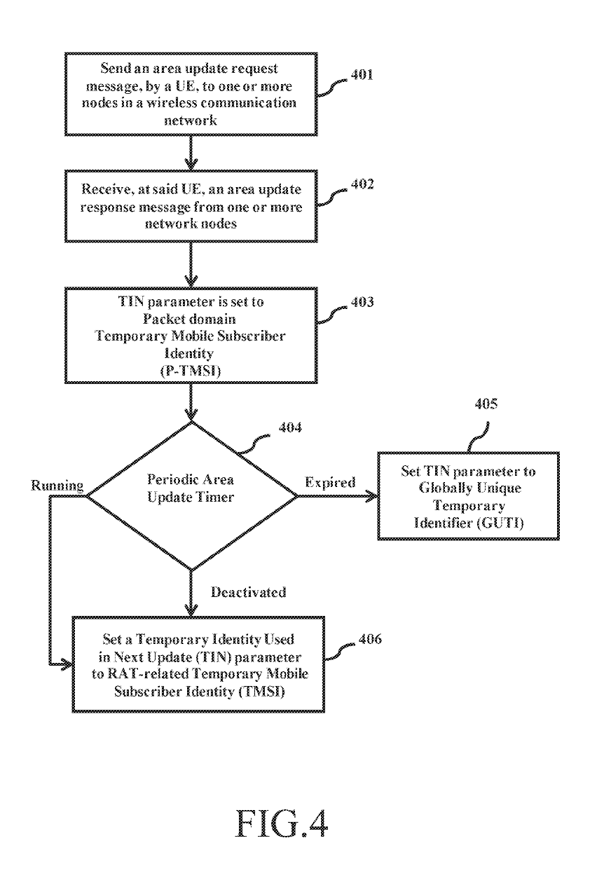

FIG. 4 is a flow chart illustrating a method for preserving an active state of an ISR function in a wireless communication network during an Inter-RAT/System change from a UTRAN/GERAN to an E-UTRAN, according to an embodiment of the present disclosure. Specifically, the method illustrated in FIG. 4 and other descriptions described herein provide a basis for a control program which can be implemented using a microcontroller, a microprocessor, or any computer readable storage medium.

Referring to FIG. 4, in step 401, the area update request message, e.g., a TAU request message, is sent by a UE to a node, i.e., an MME, in the wireless communication network to initiate a TAU procedure. Herein, the MME may be referred to as a target MME, and an SGSN may be referred to as a source SGSN during an Inter-RAT/System change from a UTRAN/GERAN to an E-UTRAN.

After receiving the TAU request message, the target MME knows that the UE has arrived to the target side, and informs the source SGSN by sending a Forward Relocation Complete Notification (ISR Activated, Serving GW change) message. The target MME indicates to the source SGSN that the UE's context is maintained, when the Forward Relocation Complete Notification message indicates that the ISR is activated. Further, the source SGSN acknowledges the Forward Relocation Complete Notification message. Thereafter, the target MME activates the ISR in order to maintain the UE's context.

Further, at step 402, the UE 102 receives an area update response message from the target MME 104. The area update response message comprises a TAU ACCEPT message. The TAU ACCEPT message indicates that the ISR is activated. At step 403, the UE has stored the TIN parameter as P-TMSI.

In step 404, the UE checks the status of a periodic area update timer, T3312.

In step 406, the UE sets a TIN parameter to a RAT-related TMSI when the status of T3312 is deactivated (or not running) or running. As described above, the setting of the TIN parameter to the RAT-related TMSI preserves deactivation of the ISR.

However, in step 405, the UE sets the TIN parameter to a GUTI, when the status of T3312 is expired.

The various steps illustrated in FIG. 4 may be performed in the order presented, in a different order, or simultaneously. Further, in some embodiments, some steps may be omitted, added, modified, skipped, and the like, without departing from the scope of the method.

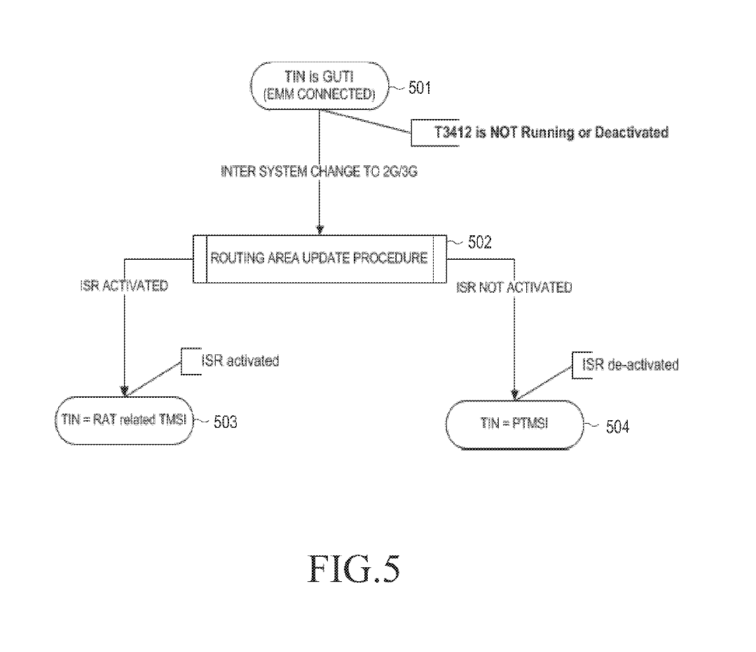

FIG. 5 is a flow chart illustrating a method for setting a TIN parameter in a UE during an Inter-RAT/System change from an E-UTRAN to a UTRAN/GERAN, according to an embodiment of the present disclosure.

Herein, the E-UTRAN may be referred to as a 4^{th} Generation (4G) network and the UTRAN/GERAN may be referred to as a 2G or 3G network.

Referring to FIG. 5, in step 501, the TIN parameter is set to a GUTI, as the UE is in an Evolved Packet System (EPS) Mobility Management CONNECTED (EMM_CONNECTED) mode, and attached to the 4G network. Because the TIN parameter is set to the GUTI, the periodic area update timer T3412 is deactivated.

In step 502, the UE initiates an RAU procedure during an inter system change of the UE from the 4G network to the 3G network or from the 4G network to the 2G network.

After successful attachment to the 3G or 2G network, the UE receives an RAU accept message, which indicates whether the ISR is activated by an SGSN.

In step 503, the UE sets the TIN parameter to the RAT-related TMSI, when the ISR is activated by the SGSN. However, in step 504, the UE sets the TIN parameter to a PTMSI, when the ISR is not activated by the SGSN.

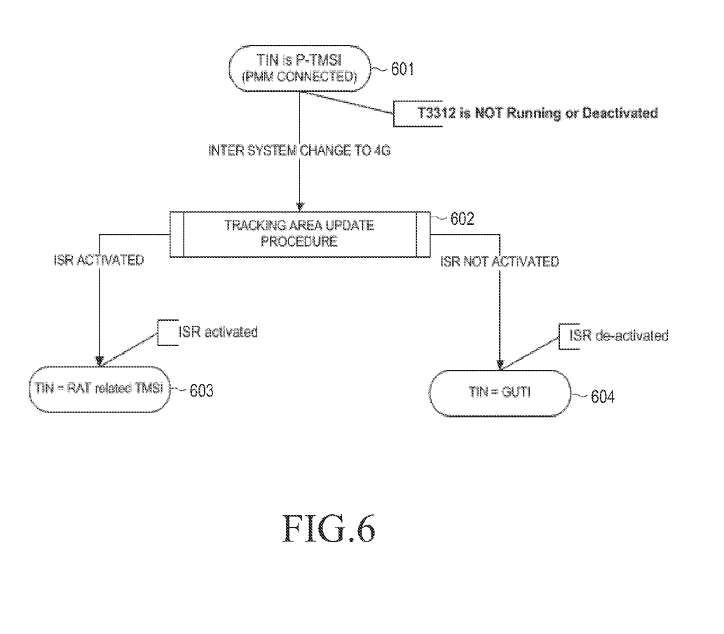

FIG. 6 is a flow chart illustrating a method for setting a TIN parameter in a UE during an Inter-RAT/System change from a UTRAN/GERAN to an E-UTRAN, according to an embodiment of the present disclosure.

Herein, the E-UTRAN may be referred to as a 4G network and the UTRAN/GERAN may be referred to as a 2G or 3G network.

Referring to FIG. 6, in step 601, the TIN parameter is set to a PTMSI in the EMM_CONNECTED mode, as the UE is attached to the 3G or 2G network. Because the TIN parameter is set to the PTMSI, the periodic area update timer T3312 is deactivated.

In step 602, the UE initiates the TAU procedure during an inter system change of the UE from the 2G or 3G network to the 4G network. After successful attachment to the 4G network, the UE receives the TAU message, which indicates whether the ISR is activated by an MME.

In step 603, the UE sets the TIN parameter to the RAT-related TMSI, when the ISR is activated by the MME. However, in step 604, the UE sets the TIN parameter to a GUTI, when the ISR is not activated by the MME.

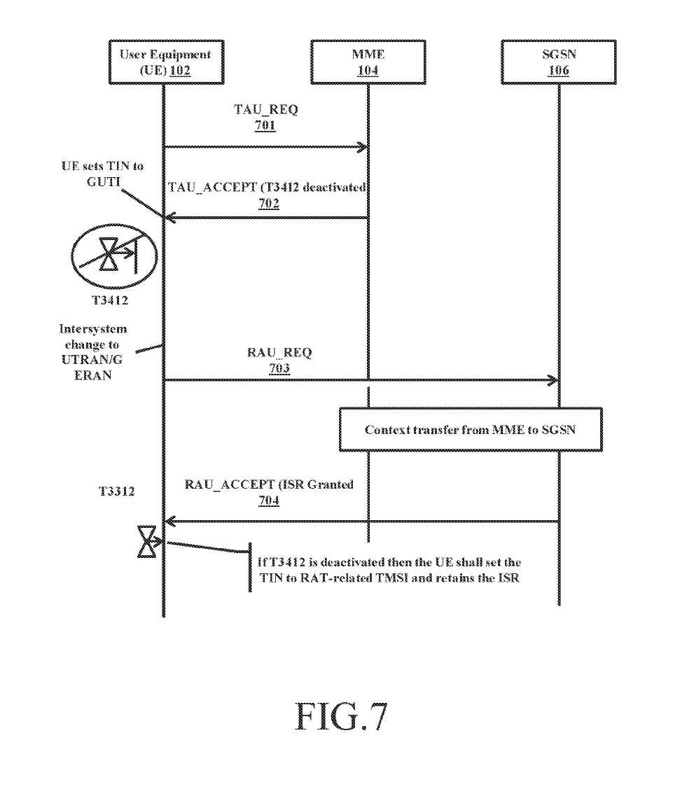

FIG. 7 is a sequence diagram illustrating a method for preserving an active state of an ISR function in a wireless communication network during an Inter-RAT/System change from an E-UTRAN to a UTRAN/GERAN, according to an embodiment of the present disclosure.

Referring to FIG. 7, in step 701, the UE 102 initiates a TAU procedure by sending a TAU request to the MME 104.

In step 702, the MME 104 sends, to the UE 102, a TAU ACCEPT message indicating deactivation of the periodic area update timer T3412.

In response to the TAU ACCEPT message, the UE 102 deactivates T3412 and sets the TIN parameter to a GUTI. Thereafter, the UE 102 is in an EMM_CONNECTED mode.

To initiate the Inter-RAT/System change to a UTRAN/GERAN, in step 703, the UE 102 sends a RAU request message to the SGSN 106. The SGSN 106 retrieves context information of the UE 102 from the MME 104.

In step 704, the SGSN 106 grants the ISR to the UE 102 in a RAU ACCEPT message.

Thereafter, the UE 102 sets the TIN parameter to the RAT-related TMSI, when the ISR is activated by the SGSN 106 and T3412 is deactivated or not running. The UE 102 retains the ISR by setting the TIN parameter to the RAT-related TMSI, thereby reducing mobile signaling between the UE 102 and the network.

The activation of the ISR by the UE 102 also increases the battery life of the UE 102, due to the mobile signaling reduction.

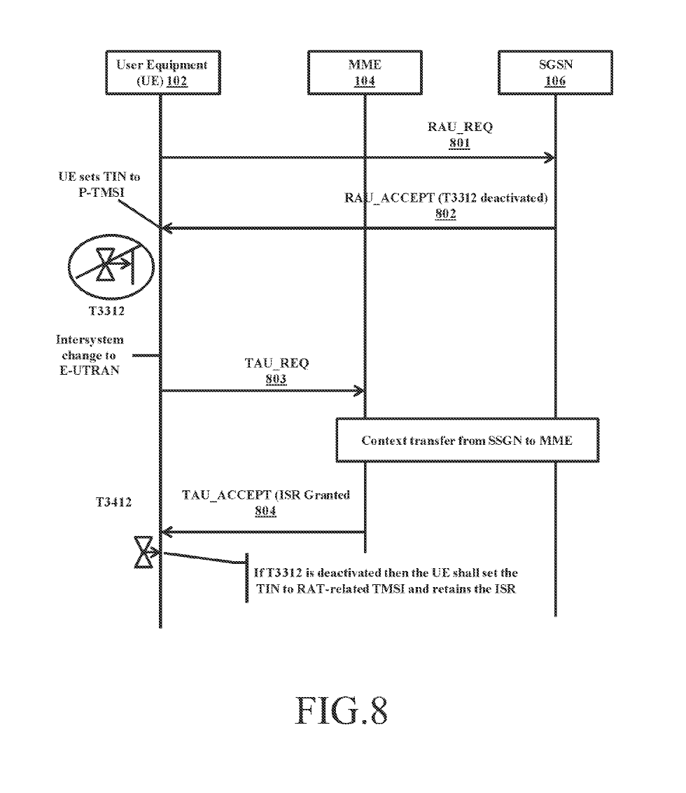

FIG. 8 is a sequence diagram illustrating a method for preserving an active state of an ISR function in a wireless communication network during an Inter-RAT/System change from a UTRAN/GERAN to an E-UTRAN, according to an embodiment of the present disclosure.

Referring to FIG. 8, in step 801, the UE 102 initiates a RAU procedure by sending a RAU request to the SGSN 106.

In step 802, the SGSN 106 sends, to the UE 102, a RAU ACCEPT message indicating deactivation of the periodic area update timer T3312.

In response to the RAU ACCEPT message, the UE 102 deactivates T3312 and sets the TIN parameter to a P-TMSI. Thereafter, the UE 102 is in a Packet Mobility Management (PMM)_CONNECTED mode.

In step 803, to initiate the Inter-RAT/System change to the E-UTRAN, the UE sends a TAU request message to the MME 104. Thereafter, the MME 104 retrieves context information of the UE 102 from the SGSN 106.

In step 804, the MME 104 grants the ISR to the UE 102 in a TAU ACCEPT message.

Thereafter, the UE 102 sets the TIN parameter to the RAT-related TMSI, when the ISR is activated by the MME 104 and T3312 is deactivated or not running. The UE 102 retains the ISR by setting the TIN parameter to the RAT-related TMSI, thereby reducing mobile signaling between the UE 102 and the network.

Further, the activation of the ISR by the UE 102 also increases the battery life of the UE 102, due to the mobile signaling reduction.

According to the embodiments of the disclosure, the related description of the standard specification (3GPP TS 24.008 and 3GPP TS 24.301) for an Inter-RAT/System change from a 4G network to a 2G or 3G network, and from a 2G or 3G network to a 4G network may be modified as follows (referring to the underline text):

In 3GPP TS 24.008, section 4.7.5.1.3 Normal and periodic routing area updating procedure accepted by the network includes:

If the ROUTING AREA UPDATE ACCEPT message contains:

i) no indication that ISR is activated, an MS supporting S1 mode shall set the TIN to “P-TMSI”; or

ii) an indication that ISR is activated, then:
if the MS is required to perform tracking area updating for IMS voice termination as specified in annex P.5, the MS shall set the TIN to “P-TMSI”;
if the MS had initiated the routing area updating procedure due to a change in the UE's usage setting or the voice domain preference for E-UTRAN, the MS shall set the TIN to “P-TMSI”; or
the MS shall regard the available GUTI and TAI list as valid and registered with the network. If the TIN currently indicates “GUTI” and the periodic tracking area update timer T3412 is running or is deactivated, the MS shall set the TIN to “RAT-related TMSI”. If the TIN currently indicates “GUTI” and the periodic tracking area update timer T3412 has already expired, the MS shall set the TIN to “P-TMSI”.

In 3GPP TS 24.301, section 5.5.3.2.4 Normal and periodic tracking area updating procedure accepted by the network includes:

The network may also indicate in the EPS update result IE in the TRACKING AREA UPDATE ACCEPT message that ISR is active. If the UE is attached for emergency bearer services, the network shall indicate in the EPS update result IE in the TRACKING AREA UPDATE ACCEPT message that ISR is not activated. If the TRACKING AREA UPDATE ACCEPT message contains:

i) no indication that ISR is activated, the UE shall set the TIN to “GUTI”;

ii) an indication that ISR is activated, then:
if the UE is required to perform routing area updating for IMS voice termination as specified in 3GPP TS 24.008 [13], annex P.5, the UE shall set the TIN to “GUTI”;
if the UE had initiated the tracking area updating procedure due to a change in UE network capability or change in DRX parameters, the UE shall set the TIN to “GUTI”;
if the UE had initiated the tracking area updating procedure due to a change in the UE's usage setting or the voice domain preference for E-UTRAN, the UE shall set the TIN to “GUTI”; or
the UE shall regard a previously assigned P-TMSI and RAI as valid and registered with the network. If the TIN currently indicates “P-TMSI” and the periodic routing area update timer T3312 is running or is deactivated, the UE shall set the TIN to “RAT-related TMSI”. If the TIN currently indicates “P-TMSI” and the periodic routing area update timer T3312 has already expired, the UE shall set the TIN to “GUTI”.

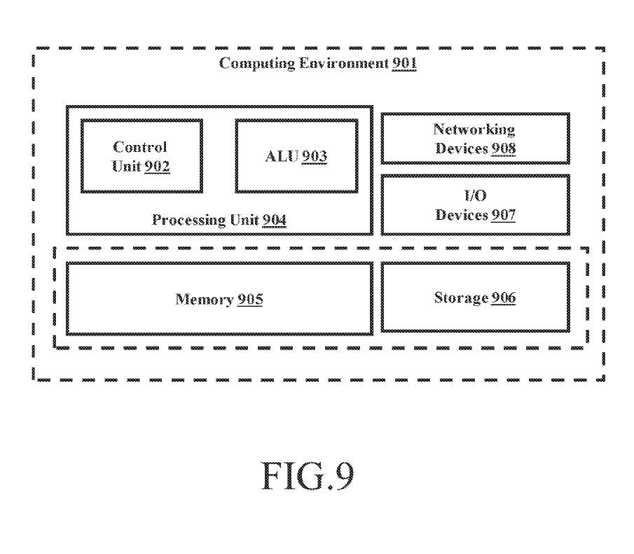

FIG. 9 illustrates a computing environment for implementing a method for preserving an active state of ISR function in a wireless communication network, in accordance with an embodiment of the present disclosure.

Referring to FIG. 9, the computing environment 901 includes a processing unit 904, which includes a control unit 902 and an Arithmetic Logic Unit (ALU) 903, a memory 905, a storage unit 906, networking devices 908, and Input output (I/O) devices 907.

The processing unit 904 is responsible for processing instructions of an algorithm, e.g., corresponding to the methods illustrated in FIGS. 3 to 6.

The processing unit 904 receives commands from the control unit 902 in order to perform processing. Further, any logical and arithmetic operations involved in the execution of the instructions are computed using the ALU 903.

The overall computing environment 901 can be composed of multiple homogeneous and/or heterogeneous cores, multiple Central Processing Units (CPUs) of different kinds, special media, and other accelerators. Further, the plurality of processing units 908 may be located on a single chip or over multiple chips.

The algorithm including instructions and/or codes for implementation are stored in the memory unit 905 and/or the storage 906. At the time of execution, the instructions may be fetched from the corresponding memory 905 and/or storage 906, and executed by the processing unit 904.

In case of any hardware implementations, various networking devices 908 or external I/O devices 907 may be connected to the computing environment to support the implementation through a networking unit and an I/O device unit.

The embodiments disclosed herein can be implemented through at least one software program running on at least one hardware device and performing network management functions to control the elements. FIGS. 2 through 9 include step and/or blocks that can be at least one of a hardware device, or a combination of hardware device and software module.

While the disclosure has been particularly shown and described with reference to certain embodiments thereof, it will be understood by those of ordinary skill in the art that various changes in form and details may be made therein without departing from the spirit and scope of the embodiments as defined by the following claims and their equivalents.

What is claimed is:

1. A method of a User Equipment (UE) for preserving an active state of an Idle Mode Signaling Reduction (ISR) function in a wireless communication network, the method comprising:
sending, by the UE, during an Inter-Radio Access technology (RAT)/System change, an area update request message to a node in the wireless communication network;
receiving, by the UE, an area update accept message from the node; and
setting, by the UE, a Temporary Identity Used in Next Update (TIN) parameter to a RAT-related Temporary Mobile Subscriber Identity (TMSI) to preserve the ISR function, in response to receiving the area update accept message, when a status of a periodic area update timer is deactivated.

2. The method of claim 1, wherein the TIN parameter is set to the RAT-related TMSI, when a Globally Unique Temporary Identifier (GUTI) is stored in the TIN parameter associated with the UE.

3. The method of claim 1, wherein the TIN parameter is set to the RAT-related TMSI, when a Packet domain-TMSI (P-TMSI) is stored in the TIN parameter associated with the UE.

4. The method of claim 1, wherein the area update request message includes one of a Routing Area Update (RAU) request message and a Tracking Area Update (TAU) request message.

5. The method of claim 1, wherein the area update accept message includes one of a Routing Area Update (RAU) ACCEPT message, and a Tracking Area Update (TAU) ACCEPT message.

6. The method of claim 1, wherein the Inter-RAT/System change is performed from a first network entity to a second network entity, and
wherein the first network entity is associated with a first network and the second network entity is associated with a second network.

7. The method of claim 1, wherein the periodic area update timer includes one of a T3412 timer and a T3312 timer.

8. The method of claim 1, wherein preserving the active state of the ISR function avoids deactivation of the ISR function by the UE.

9. A User Equipment (UE) configured for preserving an active state of an Idle Mode Signaling Reduction (ISR) function in a wireless communication network, the UE comprising:
a transceiver; and
a controller configured to:
send, via the transceiver, during an Inter-Radio Access technology (RAT)/System change, an area update request message to a node in the wireless communication network;
receive, via the transceiver, an area update accept message from the network node; and
set a Temporary Identity Used in Next Update (TIN) parameter to a RAT-related Temporary Mobile Subscriber Identity (TMSI) to preserve the ISR function, in response to receiving the area update accept message, when a status of a periodic area update timer is deactivated.

10. The UE of claim 9, wherein the TIN parameter is set to the RAT-related TMSI, when a Globally Unique Temporary Identifier (GUTI) is stored in the TIN parameter associated with the UE.

11. The UE of claim 9, wherein the TIN parameter is set to the RAT-related TMSI, when a Packet domain-TMSI (P-TMSI) is stored in the TIN parameter associated with the UE.

12. The UE of claim 9, wherein the area update request message comprises one of a Routing Area Update (RAU) request message and a Tracking Area Update (TAU) request message.

13. The UE of claim 9, wherein the area update accept message comprises one of a Routing Area Update (RAU) ACCEPT message, and a Tracking Area Update (TAU) ACCEPT message.

14. The UE of claim 9, wherein the Inter-RAT/System change is performed from a first network entity to a second network entity, and
wherein the first network entity is associated with a first network and the second network entity is associated with a second network.

15. The UE of claim 9, wherein the periodic area update timer comprises one of a T3412 timer and a T3312 timer.

16. The UE of claim 9, wherein the active state of the ISR function is preserved to avoid deactivation of the ISR function by the UE.
